(19) United States
(12) Patent Application Publication
(10) Pub. No.: US 2025/0393051 A1
(43) Pub. Date: Dec. 25, 2025

(54) SYSTEM AND METHOD FOR IMPLEMENTING PHYSICAL LAYER ARCHITECTURE OF BASE STATION IN HETEROGENEOUS COMPUTING PLATFORM

(71) Applicant: JIO PLATFORMS LIMITED, Ahmedabad (IN)

(72) Inventors: Vinod Kumar SINGH, Navi Mumbai, Maharashtra (IN); Veera Sai Satyanarayana Prasad MARNI, Navi Mumbai, Maharashtra (IN); Hiren PATEL, Navi Mumbai, Maharashtra (IN); Kumar Vishal RAI, Distt-Parthankot, Punjab (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad (IN)

(21) Appl. No.: 18/880,347

(22) PCT Filed: Sep. 30, 2023
(86) PCT No.: PCT/IB2023/059830

§ 371 Date: Dec. 31, 2024

(30) Foreign Application Priority Data
Sep. 30, 2022 (IN) 202221056389

(51) Int. Cl. H04W 72/23; H04L 5/00

(52) U.S. Cl. CPC H04W 72/23; H04L 5/0048

(57) ABSTRACT

The present disclosure provides a system and method for implementing a physical layer architecture of base station in a heterogeneous platform, which involves time critical, computationally intensive, and huge data processing modules or processes. There are various channels in L1 which require time bound processing and each channel may be present multiple times. Implementation of all these channels over hardware requires huge amount of processing resources, complexity, and time. The system describes an overall L1 architecture in the heterogeneous computing platform, segregating the implementation of different modules or processes of L1 between Processing System (PS) and Programmable Logic (PL) system in an intelligent way to efficiently use the PL resources as well as PS core processing capabilities. The system also details a way of storing the output data of each protocol data unit (PDU) in bits instead of modulated complex samples, thereby saving memory.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for a base station physical layer implementation of a wireless telecommunications network. More particularly, the present disclosure relates to a system and a method for implementing a physical layer architecture of base station in a heterogeneous computing platform.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The physical layer (L1) implementation of a base station in wireless communication technology defined by fifth generation (5G) new radio (NR) involves time critical, computationally intensive, and huge data processing modules or processes. There are various channels in L1 which require time bound processing, where each channel may be present multiple times. Implementation of all these channels over hardware may require huge amount of processing resources, complexity, and time. Further, in the 5G NR wireless communication technology, L1 of the base station consists of various downlink and uplink physical channels as defined by standards. In downlink, there are synchronization signal block (SSB), physical downlink control channel (PDCCH), physical downlink shared channel (PDSCH), and channel state information-reference signal (CSI-RS) channels. In uplink, there are physical random access channel (PRACH), physical uplink shared channel (PUSCH), physical uplink control channel (PUCCH), and sounding reference signal (SRS) channels. Some of the channels in both downlink (DL) and uplink (UL) also have associated demodulated reference signals (DMRS). Each chain contains different modules like cyclic redundancy check (CRC), channel coding, rate (de) matching, (de) modulation, and (de) mapping defined by standards for efficient recovery of the signal in a wireless channel. However, these channels/modules need to be processed within a slot, i.e., with a time constraint.

There is, therefore, a need in the art to provide a system and a method that can mitigate the challenges associated with the prior art(s).

### OBJECTS OF THE INVENTION

Some of the objects of the present disclosure, which at least one embodiment herein satisfies are listed herein below.

It is an object of the present disclosure to provide a system and a method for a Layer 1 (L1) base station architecture in a heterogeneous computing platform, where segregation of different modules or processes of L1 between a processing system (PS) and a programmable logic (PL) is implemented in an intelligent way to efficiently use the PL resources as well as PS core processing capabilities.

It is an object of the present disclosure to provide a system and a method where the PL architecture design enables efficient memory usage.

It is an object of the present disclosure to provide a system and a method where the base station architecture of L1 is placed in appropriate places to utilize efficient hardware (PL) as well as software (PS) capabilities of the platform.

It is an object of the present disclosure to provide a system and a method where both physical downlink shared channel (PDSCH) and physical downlink control channel (PDCCH) demodulation reference signal (DMRS) generation is shifted to PS and the generated DMRS output data of each protocol data unit (PDU) is stored in bits.

It is an object of the present disclosure to provide a system and a method where physical broadcast channel (PBCH) data and PDCCH data processing including common tasks have been shifted to the PL.

It is an object of the present disclosure to provide a system and a method where a synchronization signal block (SSB) generated via the PL is processed in parallel with the PDSCH data processing.

It is an object of the present disclosure to provide a system and a method where a channel state information-reference signal (CSI-RS) generation is performed via the PL.

It is an object of the present disclosure to provide a system and a method where the bits are saved instead of modulated complex symbols for each chain of encoded information, thereby providing huge benefits in memory saving.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system including one or more processors, where the one or more processors are associated with a processing system (PS) and a programmable logic (PL) system configured in the system. The system includes a memory operatively coupled with the one or more processors. The memory stores instructions which, when executed by the one or more processors, causes the one or more processors to receive a slot message from a Layer 2 (L2) via the PS. The one or more processors extract one or more protocol data unit (PDU) messages from the slot message. The one or more PDU messages include one or more mapping parameters associated with one or more downlink channels. The one or more processors of the PS, pre-process the one or more PDU messages to generate control information associated with the one or more downlink channels and then transfer the control information along with the mapping parameters to the PL. The one or more processors generate a resource grid associated with the one or more mapping parameters and enable processing of the resource grid and the control information via the PL system. The one or more processors enable processing of a physical broadcast channel (PBCH) and a physical downlink control channel (PDCCH) via the PL system based on the one or more mapping parameters and the control information. The one or more processors simultaneously enable processing of the SSB and a physical downlink shared channel (PDSCH) of the one or more downlink channels via the PL system based on the one or more mapping parameters and the control information. The one or more processors store one or more bits associated with the PDU prior to a modulation stage based on the one or more mapping parameters and the control information.

In an embodiment, the one or more processors may generate a channel state-information reference signal (CSI-RS) via the PL system.

In an embodiment, the one or more processors may generate one or more demodulation reference signal (DMRS) bits via the PS associated with the PDCCH and the PDSCH.

In an embodiment, the one or more processors may extract the one or more PDU messages received over a femto application platform interface (FAPI) decoder via the PS.

In an embodiment, the one or more mapping parameters may include at least one of a SSB mapping parameter, a PDCCH mapping parameter, a PDSCH mapping parameter, and a CSI-RS mapping parameter.

In an embodiment, the one or more processors may generate the control information via a pre-processor Application Programming Interface (API) of the PS.

In an embodiment, the one or more processors may transfer the generated control information to a RE mapper of the PL system.

In an embodiment, the PS may process the slot message and transfer the control information to the PL system.

In an aspect, the present disclosure relates to a method. The method includes receiving, by one or more processors associated with a system, a slot message from a L2 layer via the PS. The method includes extracting, by the one or more processors, one or more PDU messages from the slot message. The one or more PDU messages include one or more mapping parameters associated with one or more downlink channels. The method includes pre-processing, by the one or more processors, the one or more PDU messages to generate control information associated with the one or more downlink channels via a PS of the system. The method includes generating, by the one or more processors, a resource grid including a SSB associated with the one or more mapping parameters and enabling processing of the resource grid and the control information via the PL system. The method includes enabling processing, by the one or more processors, of a PBCH and a PDCCH via the PL system based on the one or more mapping parameters and the control information. The method includes simultaneously enabling, by the one or more processors, processing of the SSB and a PDSCH of the one or more downlink channels via the PL system based on the one or more mapping parameters and the control information. The method includes storing, by the one or more processors, one or more bits associated with the one or more PDU messages prior to a modulation stage based on the one or more mapping parameters and the control information.

In an embodiment, the method may include generating, by the one or more processors, a CSI-RS via the PL system.

In an embodiment, the method may include generating, by the one or more processors, one or more DMRS bits via the PS associated with the PDCCH and the PDSCH.

In an embodiment, the method may include extracting, by the one or more processors, the one or more PDU messages received over a FAPI decoder via the PS.

In an embodiment, the method may include generating, by the one or more processors, the control information via a pre-processor API of the PS.

In an embodiment, the method may include transferring, by the one or more processors, the one or more bits and the generated control information to a RE mapper of the PL system.

In an aspect, a non-transitory computer readable medium includes a processor with executable instructions that cause the processor to receive a slot message from a L2 layer via a processing system (PS) of a base station. The processor extracts one or more PDU messages from the slot message. The one or more PDU messages include one or more mapping parameters associated with one or more downlink channels. The processor pre-processes the one or more PDU messages to generate control information associated with the one or more downlink channels via the PS (102). The processor generates a resource grid including a SSB associated with the one or more mapping parameters and enables processing of the resource grid and the control information via a PL system of the base station. The processor enables processing of a PBCH and a PDCCH via the PL system based on the one or more mapping parameters and the control information. The processor simultaneously enables processing of the SSB and a PDSCH via the PL system of the one or more downlink channels based on the one or more mapping parameters and the control information. The processor stores one or more bits associated with the one or more PDU messages prior to a modulation stage based on the one or more mapping parameters and the control information.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example diagram (300) of a conventional heterogeneous platform of a base station.

FIG. 4 illustrates an example diagram (400) for generation of physical broadcast channel (PBCH) data, in accordance with an embodiment of the present disclosure.

FIG. 5 illustrates an example diagram (500) for PBCH-demodulation reference signal (PBCH-DMRS) generation, in accordance with an embodiment of the present disclosure.

FIG. 6 illustrates an example diagram (600) of a synchronization signal block (SSB) in a resource grid, in accordance with an embodiment of the present disclosure.

FIG. 7 illustrates an example diagram (700) of physical downlink control channel (PDCCH) generation, in accordance with an embodiment of the present disclosure.

FIG. 8 illustrates an example diagram (800) of PDCCH DMRS generation, in accordance with an embodiment of the present disclosure.

FIG. 9 illustrates an example diagram (900) of a physical downlink shared channel (PDSCH) data generation, in accordance with an embodiment of the present disclosure.

FIG. 10 illustrates an example diagram (1000) of PDSCH DMRS generation, in accordance with an embodiment of the present disclosure.

FIG. 11 illustrates an example diagram (1100) of channel state information-reference signal (CSI-RS) generation, in accordance with an embodiment of the present disclosure.

FIG. 12 illustrates an example diagram (1200) of an optimal layer 1 of a heterogeneous computing platform of the base station, in accordance with an embodiment of the present disclosure.

FIG. 13 illustrates an example computer system (1300) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure describes a Layer 1 architecture in a heterogeneous computing platform, segregating the implementation of different modules or processes of L1 between a processing system (PS) and a programmable logic (PL). The present disclosure describes an intelligent way to efficiently use the PL resources as well as PS core processing capabilities. The present disclosure also explains a PL architecture design targeting efficient memory usage.

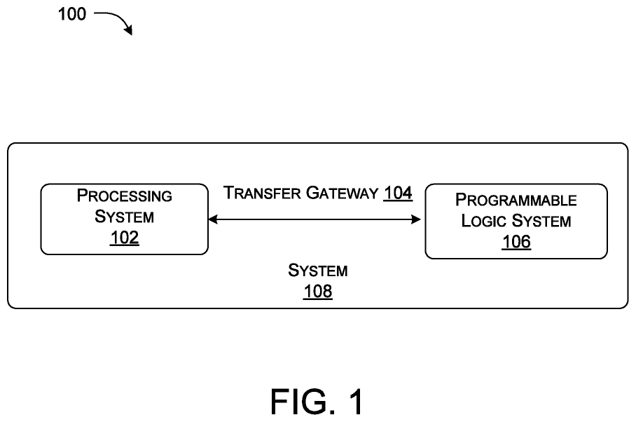

Various embodiments of the present disclosure will be explained in detail with reference to FIGS. 1-13.

FIG. 1 illustrates an example network architecture (100) for implementing a proposed system (108), in accordance with an embodiment of the present disclosure.

As illustrated in FIG. 1, the network architecture (100) may include a system (108). The system (108) may be interchangeably specified as a base station (108) throughout the disclosure. The system/base station (108) may include the heterogeneous computing platform, segregating the implementation of different modules or processes of L1 between a PS (102) and a PL system (106). The PS (102) and the PL system (106) may be communicatively coupled through a transfer gateway (104).

In an embodiment, the system (108) may include the PS (102) and the PL system (106). The PS (102) may process a slot message and transfer the generated control information to the PL system (106).

In an embodiment, the system (108) may receive a slot message from a Layer 2 (L2) configured in the base station (108) over femto application platform interface (FAPI).

In an embodiment, the system (108) may extract one or more protocol data unit (PDU) messages from the slot message. The system (108) may extract the one or more PDU messages received over a FAPI decoder via the PS (102). The PDU message may include one or more mapping parameters associated with one or more downlink channels. The one or more mapping parameters may include, but not limited to, a synchronization signal block (SSB) mapping parameter, a physical downlink control channel (PDCCH) mapping parameter, a physical downlink shared channel (PDSCH) mapping parameter, and a channel state information-reference signal (CSI-RS) mapping parameter.

In an embodiment, the system (108) may pre-process the one or more PDU messages to generate control information associated with one or more downlink channels via the PS (102) of the system (108).

In an embodiment, the system (108) may generate a resource grid including a synchronization signal block (SSB) associated with the one or more mapping parameters and enable processing of the resource grid and the control information via the PL system (106).

In an embodiment, the system (108) may enable processing of a physical broadcast channel (PBCH) and a physical downlink control channel (PDCCH) via the PL system (106) based on the one or more mapping parameters and the control information.

In an embodiment, the system (108) may simultaneously enable processing of the SSB and a PDSCH of the one or more downlink channels via the PL system (106) based on the one or more mapping parameters and the control information.

In an embodiment, the system (108) may store one or more bits associated with the one or more PDU messages prior to a modulation stage based on the one or more mapping parameters and the control information.

In an embodiment, the system (108) may generate a channel state-information reference signal (CSI-RS) via the PL system (106) for processing the resource grid.

In an embodiment, the system (108) may generate one or more demodulation reference signal (DMRS) bits via the PS (102) associated with the PDCCH and the PDSCH.

In an embodiment, the system (108) may transfer the one or more bits and the control information to a resource element (RE) mapper of the PL system (106).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

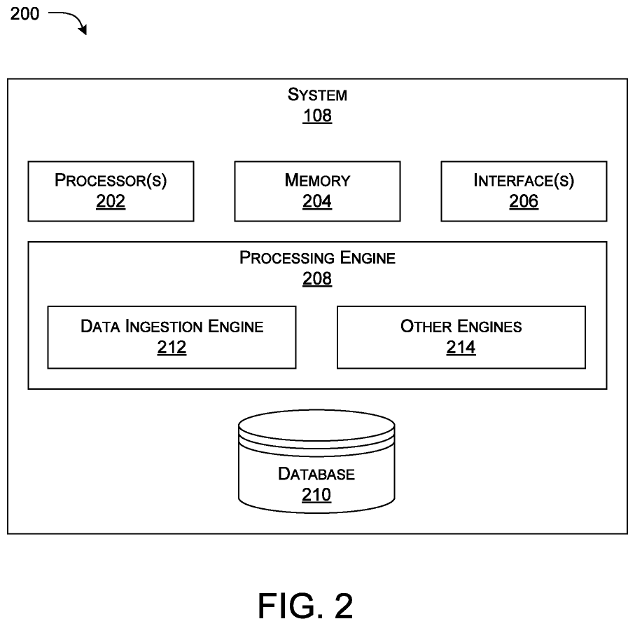

FIG. 2 illustrates an example block diagram (200) of a proposed system (108), in accordance with an embodiment of the present disclosure.

Referring to FIG. 2, the system (108), i.e. a base station may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (106). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the one or more processors (202) may receive a slot message via the data ingestion engine (212). The one or more processors (202) may receive the slot message from a L2 via a PS (102). The one or more processors (202) may store the slot message in the database (210). The PS (102) may process the slot message and transfer the processed slot message along with generated control information to a PL system (106).

In an embodiment, the one or more processors (202) may receive a slot message from a L2 configured in the base station (108) over the FAPI interface.

In an embodiment, the one or more processors (202) may extract one or more PDU messages from the slot message. The one or more processors (202) may extract the one or more PDU messages received over a FAPI decoder via the PS (102). The PDU message may include one or more mapping parameters associated with one or more downlink channels. The one or more mapping parameters may include, but not limited to, a SSB mapping parameter, a PDCCH mapping parameter, a PDSCH mapping parameter, and a CSI-RS mapping parameter.

In an embodiment, the one or more processors (202) may pre-process the one or more PDU messages to generate control information associated with one or more downlink channels via the PS (102) of the system (108).

In an embodiment, the one or more processors (202) may generate a resource grid including a SSB associated with the one or more mapping parameters and enable processing of the resource grid and the control information via the PL system (106).

In an embodiment, the one or more processors (202) may enable processing of a PBCH and a PDCCH via the PL system (106) based on the one or more mapping parameters and the control information.

In an embodiment, the one or more processors (202) may simultaneously enable processing of the SSB and a PDSCH of the one or more downlink channels via the PL system (106) based on the one or more mapping parameters and the control information.

In an embodiment, the one or more processors (202) may store one or more bits associated with the one or more PDU messages prior to a modulation stage based on the one or more mapping parameters and the control information.

In an embodiment, the one or more processors (202) may generate a CSI-RS via the PL system (106) for processing the resource grid.

In an embodiment, the one or more processors (202) may generate one or more DMRS bits via the PS (102) associated with the PDCCH and the PDSCH.

In an embodiment, the one or more processors (202) may transfer the one or more bits and the control information to a RE mapper of the PL system (106).

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

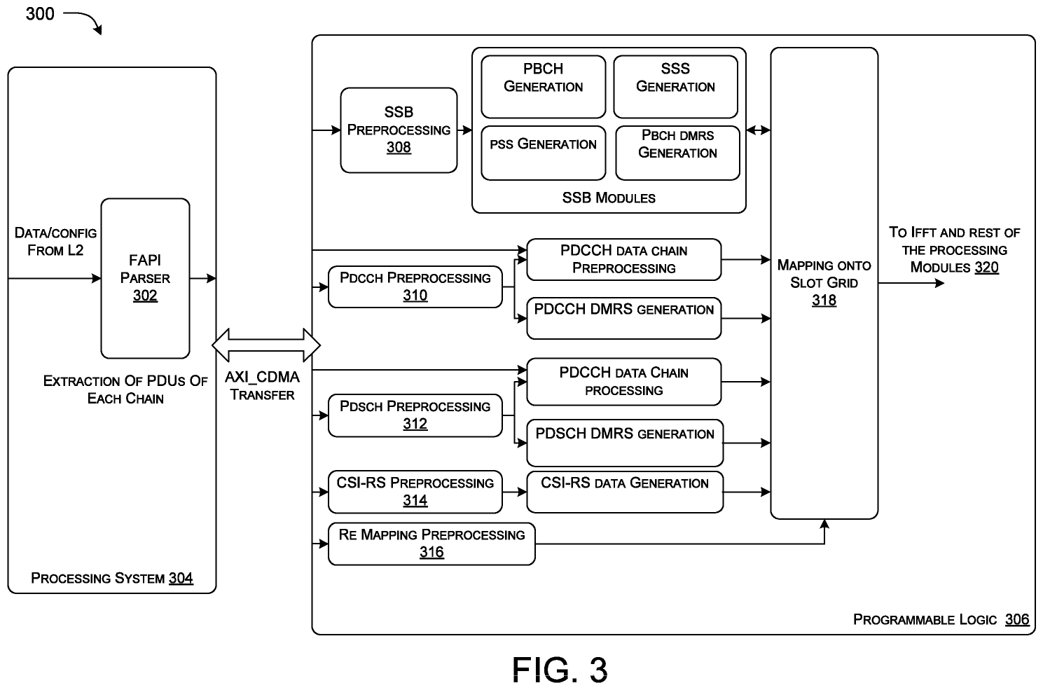

FIG. 3 illustrates an example diagram (300) of a conventional heterogeneous platform of a base station.

As illustrated in FIG. 3, the Layer 1 (L1) of a base station may include various downlink and uplink physical channels as defined by standards. In downlink (DL), the physical channels may include, but not limited to, a SSB (which may include a primary synchronization signal (PSS), a secondary synchronization signal (SSS), and a PBCH), a PDCCH, a PDSCH, and CSI-RS channels. In uplink (UL), the physical channels may include, but not limited to, a physical random access channel (PRACH), a physical uplink shared channel (PUSCH), a physical uplink control channel, (PUCCH) and sounding reference signal (SRS) channels. Some of the channels in both DL (PBCH, PDCCH, and PDSCH) and UL (PUCCH and PUSCH) may also include associated DMRS. Each chain may include different modules, but not limited to, cyclic redundancy check (CRC), channel coding (low density parity check (LDPC), polar, etc.), rate (de) matching, (de) modulation, and (de) mapping defined by standards for efficient recovery of the signal in a wireless channel.

Further, all these channels/modules need to be processed within a slot. i.e., with a time constraint of 500 microseconds (us) considering 5G NR system operating with 30 Kilohertz (KHz) sub carrier spacing. The simple and straightforward architecture for the implementation of all these channels may include placement of all the chains/modules in the PL part (306) of heterogeneous platform, as illustrated in FIG. 3. All the modules placed in PL (306) may require some control information that may be obtained by pre-processing the parameters received by L1 from L2 over L1-L2 interface like the FAPI. This kind of architecture not only requires large amount of hardware resources which makes the system complex for debugging and maintenance purposes but also leads to underutilization of the PS (304). To design a balanced architecture, the chains may be simply split and offload some of the modules from the PL (306) to the PS (304) along with corresponding pre-processing units. However, this process may generate a huge amount of data overhead that needs to be shared from PS (304) to PL (306) in real time leading to a complex system in terms of meeting the processing budget due to an increased data transfer time.

The 5G NR may be a radio access technology (RAT) developed for the 5G mobile network. The 5G NR may be based on an OFDM technology as with a fourth generation (4G) long-term evolution (LTE) network. In LTE, there is only a type of numerology or subcarrier spacing (15 KHz), whereas in NR, multiple types of subcarriers spacing may be available. For example, the 5G NR may support subcarrier spacing of 15, 30, 60, 120, and 240 KHz, where all numerology may not be used for every physical channel and signals. A specific numerology may be used only for a certain type of physical channels even though majority of the numerologies may be used for any type of physical channels. The 5G NR covers a very wide range of frequencies (e.g., sub 3 Gigahertz (GHz), sub 6 GHz and millimetre (mm)-Wave over 25 GHz) and each frequency range may include its own characteristics in terms of propagation, doppler, inter symbol interference, or the like to achieve maximum efficiency or performance with multiple subcarrier options.

As illustrated in FIG. 3, data configuration from the layer2 may be provided to FAPI parser (302) configured in the PS (304). The FAPI parser (302) may provide this information to the PL (306). The PL (306) may include SSB pre-processing (308), PDCCH pre-processing (310), PDSCH pre-processing (312), CSI-RS pre-processing (314), and RE mapping pre-processing (316). Further, all these chains may be mapped onto a slot grid (318) and provided to an Inverse Fast Fourier Transform (IFFT) module (320) and rest of the processing modules in the PL (306).

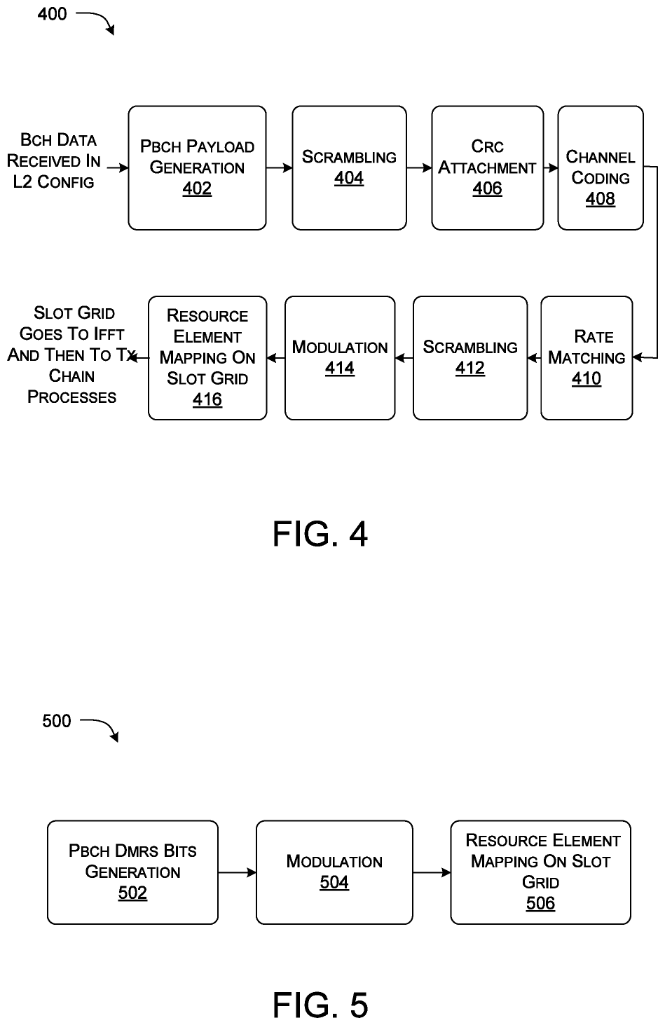

FIG. 4 illustrates an example diagram (400) for generation of physical broadcast channel (PBCH) data, in accordance with an embodiment of the present disclosure.

The SSB may include the PSS, the SSS, the PBCH, and the PBCH-DMRS. The generation of PSS and SSS may be dependent on a cell identification (ID). The PBCH-DMRS generation from a PN sequence generator may use the cell ID and a symbol number as seed. The PBCH data bits may be generated using a broadcast channel (BCH) data present in L2 configuration which may then be scrambled using a bit sequence (e.g., PN sequence). This may be followed by 24-bit CRC attachment and polar encoding. Rate matching may be performed afterwards followed by a second scrambling stage. The bits may then be quadrature phase shift keying (QPSK) modulated to make the complex symbols which may occupy a fixed location inside the SSB and mapped onto the slot grid.

As illustrated in FIG. 4, the BCH data received in the L2 configuration may be provided to a PBCH payload generation module (402), a scrambling module (404), a CRC attachment module (406), a channel coding module (408), a rate matching module (410). Further, the output from the rate matching module (410) may be provided to a second scrambling module (412), a modulation module (414), and a RE mapping on slot grid module (416). The output from the slot grid may go to the IFFT and further transmission chain processes.

FIG. 5 illustrates an example diagram (500) for PBCH-demodulation reference signal (PBCH-DMRS) generation, in accordance with an embodiment of the present disclosure.

The PN sequence generator may be used to generate the bits for PBCH-DMRS using the cell ID and a SSB index as seed. The bits may be of fixed length sequence where the QPSK modulation is applied to form the complex symbols. The bits may occupy fixed location inside the SSB which may be mapped onto the slot grid.

As illustrated in FIG. 5, the cell ID and the SSB index may be provided to a PBCH DMRS bit generation module (502). Output from the PBCH DMRS bit generation module (502) may be provided to a modulation module (504) and further to a RE mapping on slot grid module (506) for further processing.

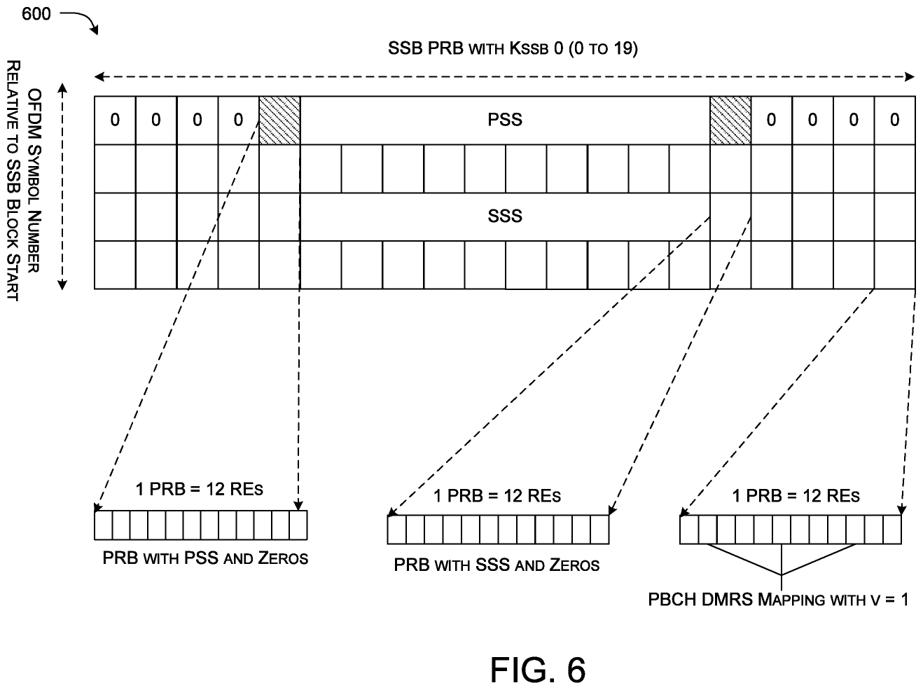

FIG. 6 illustrates an example diagram (600) of a synchronization signal block (SSB) in a resource grid, in accordance with an embodiment of the present disclosure.

As illustrated in FIG. 6, in 5G NR, synchronization signals and a PBCH may be packed as a single SSB block in a resource grid that occupies 240 subcarriers. Location of each component inside the SSB may be fixed comprising complex symbols.

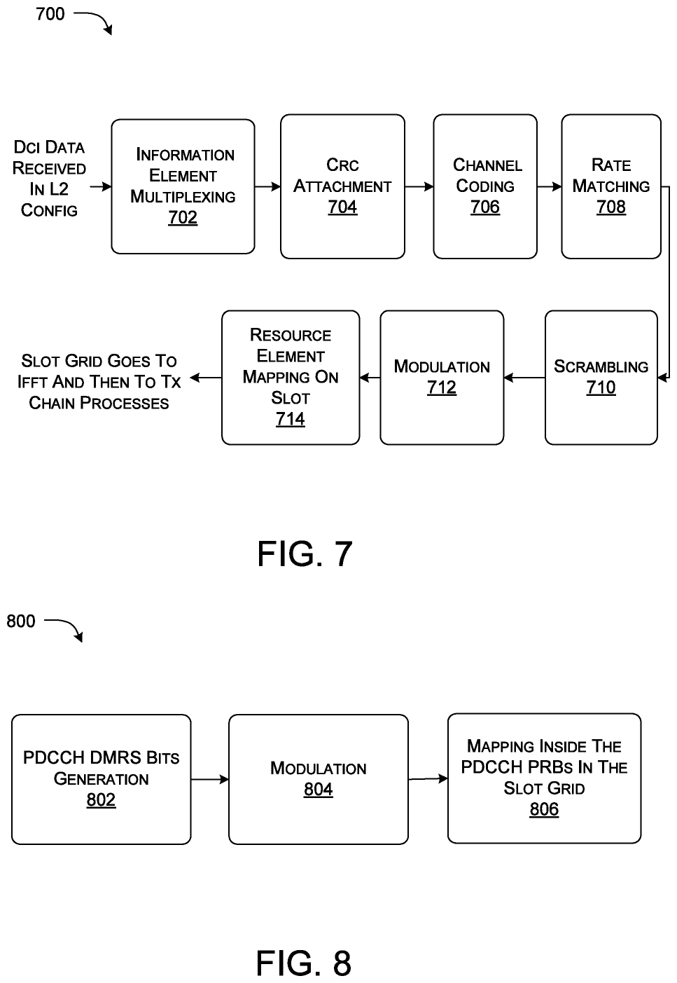

FIG. 7 illustrates an example diagram (700) of physical downlink control channel (PDCCH) generation, in accordance with an embodiment of the present disclosure.

In 5G NR, a PDCCH may be used to carry downlink control information (DCI). DCI may contain information used to schedule user data (PUSCH in UL, PDSCH in DL). This channel may be present in the interleaved or continuous pattern in a control resource set (CORESET) region of the slot grid. PDCCH may be confined to a single CORESET and transmitted with its own DMRS where the generation of PDCCH may involve various sub sections.

The DCI data received from L2 configuration may get padded with zeros depending upon its length to generate the bit payload at an information element multiplexing module (702). A 24-bit CRC attachment (704) followed by polar encoding (706) may be performed over the payload. A PDCCH channel may be transported via 1/2/4/8/16 control channel elements (CCEs) in order to accommodate different DCI payload sizes or coding rates. Rate matching (708) may be performed onto the channel coded bits. This may be followed by scrambling (710) of the rate matched bits. After scrambling (710), QPSK modulation (712) may be applied to generate complex modulated symbols. The complex modulated symbols may be mapped to physical resources on the slot grid (714) taking into consideration DMRS mapping.

FIG. 8 illustrates an example diagram (800) of PDCCH DMRS generation, in accordance with an embodiment of the present disclosure.

The PDCCH-DMRS may be generated using a PN sequence generator and the PDCCH-DMRS may occupy fixed places in the PDCCH PRB i.e. 2^{nd}, 6^{th}, and 10^{th} position among 12 subcarriers of each PRB. The PN sequence generator (802) may be used to generate the PDCCH DMRS bits. QPSK modulation (804) may be applied onto them to make complex symbols. The generation of PDCCH DMRS may be dependent on the physical resource blocks (PRBs) allocated to PDCCH PDUs. Each PDCCH DMRS sequence may be mapped inside its particular PDCCH PDU PRBs (806).

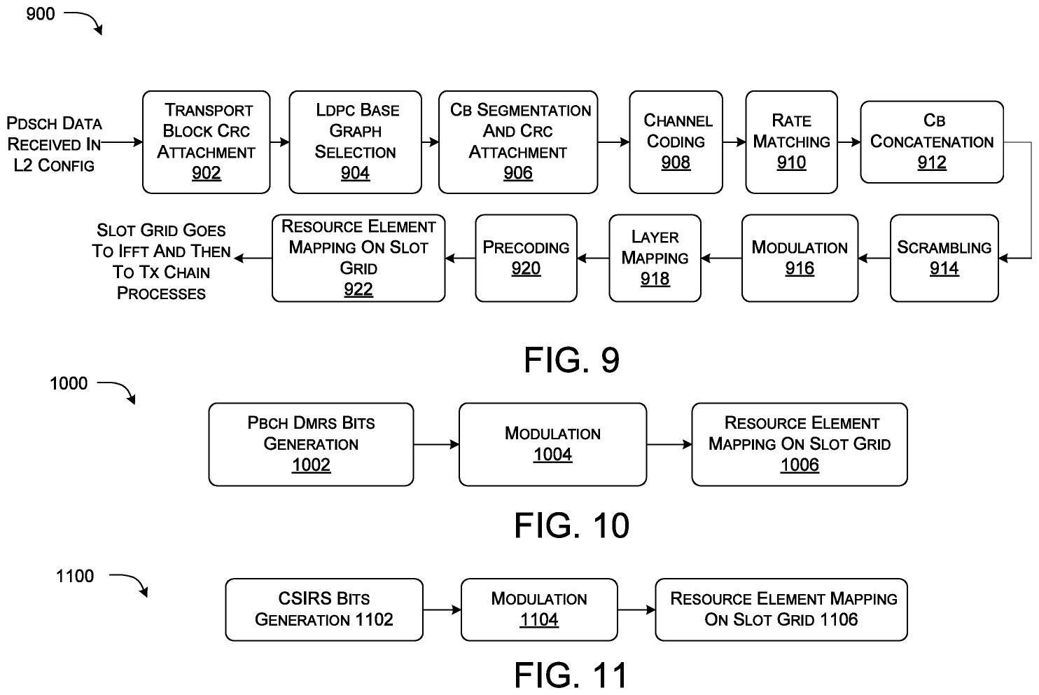

FIG. 9 illustrates an example diagram (900) of a physical downlink shared channel (PDSCH) data generation, in accordance with an embodiment of the present disclosure.

The PDSCH channel may carry DL user specific data, UE specific upper layer information, and broadcast messages like system information and paging. The PDSCH data received in the L2 configuration may firstly go through a transport block (TB) CRC attachment (902), where 16 or 24 bits of CRC may be added to the transport block. Depending upon the size of the TB, a LDPC base graph may be selected (904) and code block segmentation (906) may be performed. Each segmented block may undergo a channel coding (LDPC encoder) (908) and a rate matching process (910). All the code blocks may be then concatenated (912). The bits in the code word may be scrambled (914) using a pseudo random sequence based on a data scrambling ID and a radio network temporary identifier (RNTI). Modulation (916) may be performed on the scrambled bits max 256 QAM to form complex symbols. The complex symbols may be then mapped onto various layers (918) as provided in the input configuration. Further, precoding (920) may be used to generate multiple data streams intended for different users, and resource element mapping may be performed onto slot grid (922). These multiple data streams may be emitted from the transmit antennas with independent and appropriate weightings such that the throughput is maximized at a receiver side.

FIG. 10 illustrates an example diagram (1000) of PDSCH DMRS generation, in accordance with an embodiment of the present disclosure.

The DMRS may be present in RBs allocated for PDSCH in particular allocated symbols. A PN sequence generator may be used to generate the PDSCH DMRS bits (1002). QPSK modulation (1004) may be applied onto them to make complex symbols which may be then mapped onto the DMRS symbols allocated to the PDSCH. The generation of PDSCH DMRS may be dependent on the PRBs allocated to the PDSCH PDU. The complex symbols may be provided to a RE mapping on a slot grid (1006).

FIG. 11 illustrates an example diagram (1100) of channel state information-reference signal (CSI-RS) generation, in accordance with an embodiment of the present disclosure.

CSI-RS may be used in DL for the purpose of radio channel characteristics measurement. The UE (104) may use this channel to measure the channel information and report the channel information back to the network (106). A CSI-RS sequence may be generated using a PN sequence generator (1102) with scrambling ID, slot number, and allocated symbol and further used for seed calculation. The bit sequence may be QPSK modulated (1104) and mapped onto allocated PRBs and symbols in the slot grid (1106).

A configuration exchange may happen between L1 and L2 through a FAPI interface. The DL and UL transmission time interval (TTI) messages may be sent from Layer 2 to Layer 1 through the FAPI interface/standard per TTI. FAPI may be viewed as a subset of the network femto application platform interface (nFAPI), also published by the SCF. The PDUs received from L2 may consist of allocation parameters and channel data. Various downlink physical channels may include but not limited to PDSCH, PDCCH, DMRS (PDSCH and PDCCH), CSIRS, SSB (PSS, SSS and PBCH). The payload of each channel may be processed as per steps defined in the standard. The mapping of the processed data onto slot grid may be performed and subsequently a slot grid may be passed on to radio unit for on-air transmission.

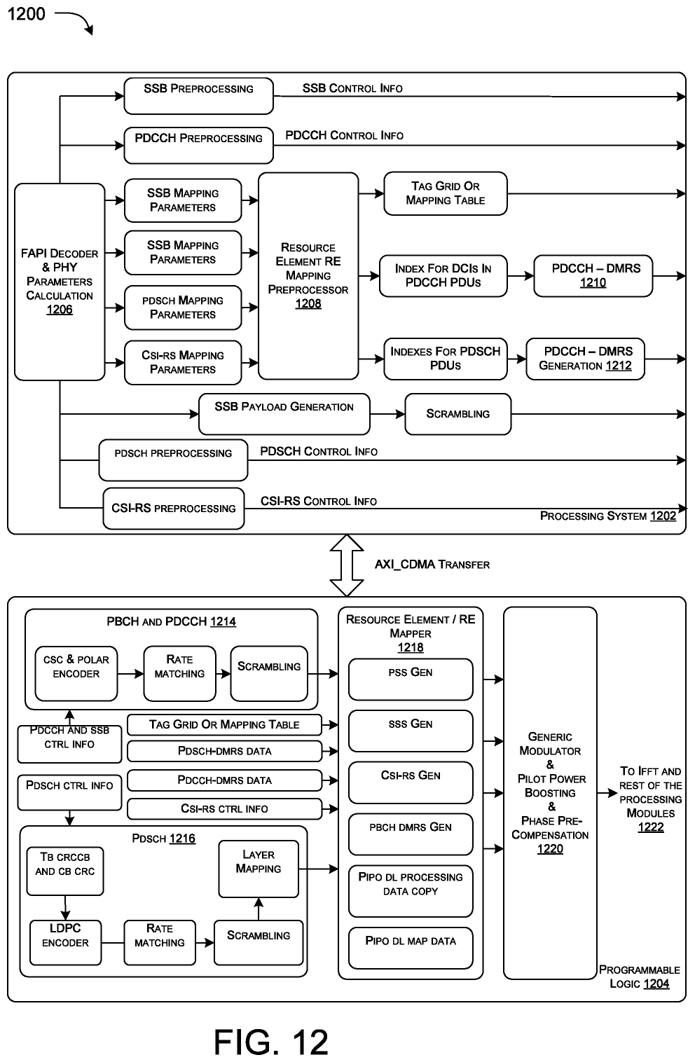

FIG. 12 illustrates an example diagram (1200) of an optimal layer 1 of a heterogeneous computing platform of the base station, in accordance with an embodiment of the present disclosure.

In an embodiment, an efficient Layer 1 architecture in a heterogeneous platform/system (108) may split the processing of various sub tasks of various channels selectively with a criterion that the placement of such modules in the PS (1202) may not add any additional transfer time from PS (1202) to PL (1204). The same is illustrated in detail below considering the 5G NR DL with 100 MHz bandwidth operating in 30 KHz subcarrier spacing. Further, the system (108) may include the FAPI interface as an example but not limited to technology or direction of operation within the technology.

In an embodiment, the PS (1202) may receive the slot messages from L2 for all the downlink channels and the FAPI parser/decoder (1206) may extract the entire physical channel PDUs from these messages. These PDUs may contain the payload and the mapping parameters. The pre-processing tasks of each DL chain which is required to generate control information for processing data and mapping of each chain may be shifted to PS (1202) to save the PL (1204) resources.

In an embodiment, the pre-processing of each PDU in PS (1202) may create control information for each chain like SSB, PDCCH, PDSCH, and CSI-RS. The RE-mapper pre-processing module present in PS (1202) may take up mapping parameters of SSB, PDCCH, PDSCH, CSI-RS chains and generate tag grid for RE mapping. This tag grid or mapping table along with all channels control information may be transferred to corresponding modules of the PL (1204) in each slot.

In an embodiment, the PBCH data and PDCCH data processing chain may include common sub tasks such as, but not limited to, CRC attachment, polar coding, rate matching, and scrambling. These common tasks may be placed in the PL (1204). PBCH data having two tasks before CRC attachment step may be shifted to the PS (1202) as this data may be small and may not impact PS-PL data transfer timing and thus provide flexibility to design a common processing chain for both channels in PL (1204). Compared to PBCH and PDCCH, the PDSCH chain may include huge data processing with a very tight budget. Hence, all PDSCH subtasks may be placed in the PL (1204) and only the pre-processing tasks that require control information for PDSCH may be placed in the PS (1202).

In an embodiment, the content of SSB may be fixed and may not require many configurations and hence the SSB may be generated in the PL (1204). Generating the SSB in PS (1202) and then transferring to PL (1204) may require an increased transfer time and resources. This may include PSS, SSS, and PBCH-DMRS generation. These generated data along with PBCH data received from the processing chain may be placed in an appropriate position in the SSB grid. The mapping of SSB data into the SSB grid may be done in parallel to the PDSCH data processing as the SSB chain may include minimal processing. This may save processing time of actual mapping onto the slot grid. Like PSS, SSS, and PBCH-DRMS channels, CSI-RS chain may also need configuration and may not take any payload from L2. Thus, the CSI-RS generation may be placed in the PL (1204). Further, generation of the CSI-RS in the PS (1202) may require an output to be transferred to the PL (1204) resulting in a higher transfer time between the PS (1202) to the PL (1204).

Further, unlike PBCH-DRMS, the DMRS generation for PDSCH and PDCCH may be dependent on the PRB allocation of the PDU. To save PL resources, the pre-processing function may be shifted to PS (1202) and generate the required control information of PRB indices as shown in Table 1. Further, the pre-processing function may require significant PS to PL data transfer time.

TABLE 1

| | PRB Indices | Memory Size |
|---|---|---|
| Channel | Array Size | (bits) |
| PDCCH DMRS | 810 | 12960 |
| PDSCH DMRS | 1092 | 17472 |
| Total Memory | | 30432 = 0.029 Mb |

In an embodiment, if the PDSCH and PDCCH DMRS generation modules are placed in PL (1204), this may lead to an underutilized PS (1202) and further add a processing delay along with additional PL resources.

In an embodiment, if the PDSCH, PDCCH DMRS generation, and modulation modules are offloaded to the PS (1202), then the generated complex data may be huge (almost 10 times more than sending only PRB indices control overhead) as shown in Table 2 which may increase the PS to PL transfer delay.

TABLE 2

| | | Memory Size |
|---|---|---|
| | DMRS Data | stored in Samples |
| Channel | Array Size | (bits) |
| PDCCH DMRS | 2457 | 78624 |
| PDSCH DMRS | 6552 | 209664 |
| Total Memory | | 288288 = 0.275 Mb |

In an embodiment, for optimal utilization of the PS (1202) and to receive the benefits of processing time, the PS to PL transfer time, and the PL resources, both the PDSCH and PDCCH DMRS generation may be shifted to the PS (1202) and the generated DMRS output data of each PDU may be stored in bits. With this approach, the generated data overhead may be less in comparison to the PRB indices control overhead as shown in Table 3, therefore saving a processing time and the PL resources.

TABLE 3

| | | Control | | DMRS Data | DMRS Data |
|---|---|---|---|---|---|
| | PRB | Overhead | DMRS | Element | Memory |
| | Indices | Memory | Data | Width based | Size stored |
| | Array | Size | Array | on Modulation | in bits |
| Channel | Size | (bits) | Size | (bits) | (bits) |
| PDCCH | 810 | 12960 | 2457 | 2 | 4914 |
| DMRS | | | | | |
| PDSCH | 1092 | 17472 | 6552 | 2 | 13104 |
| DMRS | | | | | |
| Total | | 30432 = | | | 18018 = |
| Memory | | 0.029 Mb | | | 0.0172 Mb |

This output data of each chain is stored in bits form rather than a modulated complex form (bits are modulated to form complex symbols for each chain). Saving the data in bits form rather than the modulated form may provide huge benefits in memory saving which may be more than four as shown in Table 4.

TABLE 4

| | | Element Width | | Memory Size | Memory Size |
|---|---|---|---|---|---|
| | Element/ | based on | | stored | stored in |
| | Array | Modulation | | in bits | Samples |
| Channel | Size | Bits | Samples | (bits) | (bits) |
| SSB | 1660 | 2 | 32 | 3320 | 53120 |
| PDCCH | 7371 | 2 | 32 | 14742 | 235872 |
| PDCCH | 2457 | 2 | 32 | 4914 | 78624 |
| DMRS | | | | | |
| PDSCH | 42588 | 8 | 32 | 340704 | 1362816 |
| PDSCH | 6552 | 2 | 32 | 13104 | 209664 |
| DMRS | | | | | |
| CSI-RS | 1632 | 2 | 32 | 3264 | 52224 |
| Total | | | | 380048 = | 1992320 = |
| Memory | | | | 0.362 Mb | 1.616 Mb |

In an embodiment, the RE mapper in the PL (1204) may receive all the chain's data in the bits form along with the mapping table in a slot. In the next slot, the saved data may be mapped per RE basis in “frequency first then time order” manner and may be provided to a generic modulator module for performing modulation. The mapped resource elements bits given to the modulator may carry some additional control information such as, but not limited to, a modulation order, a power offset, and a precoding matrix indicator (PMI) index for further processing.

As illustrated in FIG. 12, in an embodiment, the system (108) may include the PS (1202) and the PL (1204). The PS (1202) may include a FAPI decoder (1206) that may receive slot data associated with multiple DL physical channels and generate multiple mapping parameters based on the DL physical channels. The PS (1202) may further include a RE mapping pre-processor (1208) that may enable a PDCCH-DMRS generation (1210) and a PDSCH-DMRS generation (1212) and transmit this to the PL (1204).

In an embodiment, the PL (1204) may include PBCH and a PDCCH processing (1214) along with the PDSCH processing (1216). A RE mapper (1218) in the PL (1204) may process all this information and provide an output to a generic modulator/pilot power boosting/phase pre-compensation (1220). Further, an output from the generic modulator/pilot power boosting/phase pre-compensation (1220) may be provided to for IFFT and rest of the processing modules (1222).

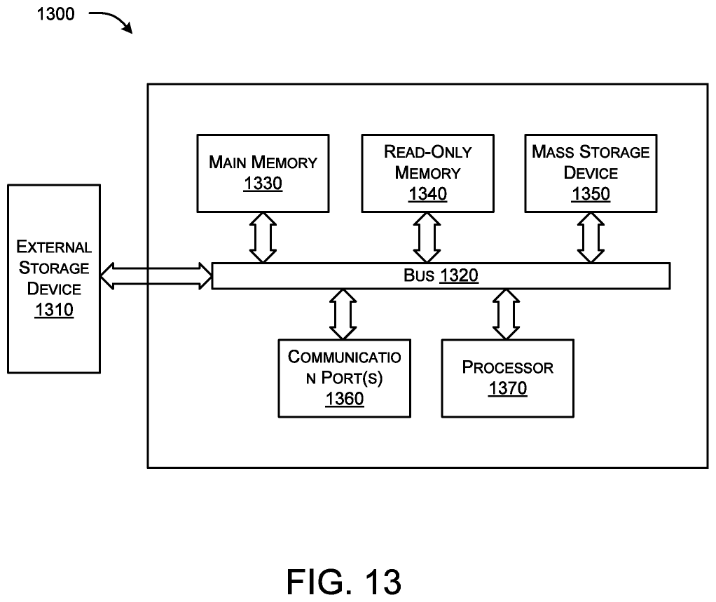

FIG. 13 illustrates an exemplary computer system (1300) in which or with which embodiments of the present disclosure may be implemented.

As shown in FIG. 13, the computer system (1300) may include an external storage device (1310), a bus (1320), a main memory (1330), a read-only memory (1340), a mass storage device (1350), a communication port(s) (1360), and a processor (1370). A person skilled in the art will appreciate that the computer system (1300) may include more than one processor and communication ports. The processor (1370) may include various modules associated with embodiments of the present disclosure. The communication port(s) (1360) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (1360) may be chosen depending on a network, such as a Local Area Network (LAN), Wide Area Network (WAN), or any network to which the computer system (1300) connects.

In an embodiment, the main memory (1330) may be Random Access Memory (RAM), or any other dynamic storage device commonly known in the art. The read-only memory (1340) may be any static storage device(s) e.g., but not limited to, a Programmable Read Only Memory (PROM) chip for storing static information e.g., start-up or basic input/output system (BIOS) instructions for the processor (1370). The mass storage device (1350) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (1320) may communicatively couple the processor(s) (1370) with the other memory, storage, and communication blocks. The bus (1320) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (1370) to the computer system (1300).

In another embodiment, operator and administrative interfaces, e.g., a display, keyboard, and cursor control device may also be coupled to the bus (1320) to support direct operator interaction with the computer system (1300). Other operator and administrative interfaces can be provided through network connections connected through the communication port(s) (1360). Components described above are meant only to exemplify various possibilities. In no way should the aforementioned exemplary computer system (1300) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method where a direct memory access (DMA) transfer time of (DMRS) signals is reduced by sending bits instead of modulated symbols.

The present disclosure provides a system and a method where processing time associated with resource element mapping is reduced by forming a synchronizing signal block (SSB) grid and mapping the SSB grid in parallel while processing data channels.

The present disclosure provides a system and a method where an efficient utilization of processing system (PS) core processors and programmable logic (PL) resources is enabled.

The present disclosure provides a system and a method where a memory requirement is reduced in PL for storing generated data in bits instead of modulated complex samples.

The present disclosure provides a system and a method where resource element (RE) mapping is performed in bits instead of complex samples before modulation and storage of generated data per each chain is done in bits instead of modulated complex samples.

The present disclosure provides a system and a method that offloads DMRS generation functionality of all channels to the PS and transfers generated DMRS signals from the PS to the PL in bits instead of modulated complex symbols.

The present disclosure provides a system and a method where physical broadcast channel (PBCH) data and PDCCH data processing including common tasks have been shifted to the PL.

The present disclosure provides a system and a method where a synchronization signal block (SSB) generated via the PL is processed in parallel with the PDSCH data processing.

The present disclosure provides a system and a method where a channel state information-reference signal (CSI-RS) generation is performed via the PL.

The present disclosure provides a system and a method that enables formation of the SSB grid from generated data of a primary synchronization signal (PSS), a secondary synchronization signal (SSS), and a physical broadcast channel (PBCH) data, a demodulation reference signal (DMRS) while processing data channels in parallel.

We claim:

1. A system (108), comprising:
one or more processors (202), wherein the one or more processors (202) are associated with a processing system (PS) (102) and a programmable logic (PL) system (106) configured in the system (108);
a memory (204) operatively coupled with the one or more processors (202), wherein the memory (204) stores instructions which, when executed by the one or more processors (202), cause the one or more processors (202) to:
receive a slot message from a Layer 2 (L2) via the PS (102);
extract one or more protocol data unit (PDU) messages from the slot message, wherein the one or more PDU messages comprise one or more mapping parameters associated with one or more downlink channels;
pre-process the one or more PDU messages to generate control information associated with the one or more downlink channels via the PS (102);
generate a resource grid comprising a synchronization signal block (SSB) associated with the one or more mapping parameters and enable processing of the resource grid and the control information via the PL system (106);
enable processing of a physical broadcast channel (PBCH) and a physical downlink control channel (PDCCH) via the PL system (106) based on the one or more mapping parameters and the control information;
simultaneously enable processing of the SSB and a physical downlink shared channel (PDSCH) of the one or more downlink channels via the PL system (106) based on the one or more mapping parameters and the control information; and
store one or more bits associated with the one or more PDU messages prior to a modulation stage based on the one or more mapping parameters and the control information.

2. The system (108) as claimed in claim 1, wherein the one or more processors (202) are to generate a channel state-information reference signal (CSI-RS) via the PL system (106).

3. The system (108) as claimed in claim 1, wherein the one or more processors (202) are to generate one or more demodulation reference signal (DMRS) bits via the PS (102) associated with the PDCCH and the PDSCH.

4. The system (108) as claimed in claim 1, wherein the one or more processors (202) are to extract the one or more PDU messages received over a femto application platform interface (FAPI) decoder via the PS (102).

5. The system (108) as claimed in claim 1, wherein the one or more mapping parameters comprise at least one of: a SSB mapping parameter, a PDCCH mapping parameter, a PDSCH mapping parameter, and a CSI-RS mapping parameter.

6. The system (108) as claimed in claim 1, wherein the one or more processors (202) are to generate the control information via a pre-processor Application Programming Interface (API) of the PS (102).

7. The system (108) as claimed in claim 1, wherein the one or more processors (202) are to transfer the control information to a resource element (RE) mapper of the PL system (106).

8. The system (108) as claimed in claim 1, wherein the PS (102) processes the slot message and transfers the control information to the PL system (106).

9. A method, comprising:
receiving, by one or more processors (202), associated with a system (108), a slot message from a Layer 2 (L2) via a programmable system (PS) (102) of the system (108);
extracting, by the one or more processors (202), one or more protocol data unit (PDU) messages from the slot message, wherein the one or more PDU messages comprise one or more mapping parameters associated with one or more downlink channels;
pre-processing, by the one or more processors (202), the one or more PDU messages to generate control information associated with the one or more downlink channels via the PS (102);
generating, by the one or more processors (202), a resource grid comprising a synchronization signal block (SSB) associated with the one or more mapping parameters and enabling processing of the resource grid and the control information via a programmable logic (PL) system (106) of the system (108);
enabling processing, by the one or more processors (202), of a physical broadcast channel (PBCH) and a physical downlink control channel (PDCCH) via the PL system (106), based on the one or more mapping parameters and the control information;
simultaneously enabling, by the one or more processors (202), processing of the SSB and a physical downlink shared channel (PDSCH) of the one or more downlink channels, via the PL system (106), based on the one or more mapping parameters and the control information; and
storing, by the one or more processors (202), one or more bits associated with the one or more PDU messages prior to a modulation stage based on the one or more mapping parameters and the control information.

10. The method as claimed in claim 9, comprising generating, by the one or more processors (202), a channel state-information reference signal (CSI-RS) via the PL system (106).

11. The method as claimed in claim 9, comprising generating, by the one or more processors (202), one or more demodulation reference signal (DMRS) bits via the PS (102) associated with the PDCCH and the PDSCH.

12. The method as claimed in claim 9, comprising extracting, by the one or more processors (202), the one or more PDU messages received over a femto application platform interface (FAPI) decoder via the PS (102).

13. The method as claimed in claim 9, comprising generating, by the one or more processors (202), the control information via a pre-processor Application Programming Interface (API) of the PS (102).

14. The method as claimed in claim 9, comprising transferring, by the one or more processors (202), the one or more bits and the control information to a resource element (RE) mapper of the PL system (106).

15. A non-transitory computer readable medium comprising a processor with executable instructions, causing the processor to:
receive a slot message from a Layer L2 via a processing system (PS) (102) of a base station;
extract one or more protocol data unit (PDU) messages from the slot message, wherein the one or more PDU messages comprise one or more mapping parameters associated with one or more downlink channels;
pre-process the one or more PDU messages to generate control information associated with the one or more downlink channels via the PS (102);
generate a resource grid comprising a synchronization signal block (SSB) associated with the one or more mapping parameters and enable processing of the resource grid and the control information via a programmable logic (PL) system (106) of the base station;
enable processing of a physical broadcast channel (PBCH) and a physical downlink control channel (PDCCH) via the PL system (106) based on the one or more mapping parameters and the control information;
simultaneously enable processing of the SSB and a physical downlink shared channel (PDSCH) of the one or more downlink channels via the PL system (106) based on the one or more mapping parameters and the control information; and
store one or more bits associated with the one or more PDU messages prior to a modulation stage based on the one or more mapping parameters and the control information.
